(19) United States
(12) Patent Application Publication
(10) Pub. No.: US 2005/0273976 A1
(43) Pub. Date: Dec. 15, 2005

(54) ADJUSTABLE ROLLER BRACKET DEVICE FOR RETRACTABLE DOOR HINGE

(75) Inventor: Samuel C. Sarver, Pemberville, OH (US)

Correspondence Address: HAHN LOESER & PARKS, LLP, One GOJO Plaza, Suite 300, AKRON, OH, 44311-1076, US

(73) Assignee: DENCO MARKETING CO., Millersburg, OH (US)

(21) Appl. No.: 10/908,454

(22) Filed: May 12, 2005

Related U.S. Application Data
(60) Provisional application No. 60/570,538, filed on May 12, 2004.

(51) Int. Cl. E05D 7/04

(52) U.S. Cl. 16/242

(57) ABSTRACT

The present invention provides an adjustable roller bracket for a retractable door hinge assembly. The adjustable roller bracket device comprises a mounting portion, wherein the mounting portion comprises a horizontal face having a first aperture and an upstanding plate member having a mounting section with a second aperture therein, an adjustable roller support portion, wherein the roller support portion comprises a tubular support member and at least a third aperture and wherein a fastener secures the roller support portion to the mounting section in a predetermined position. The roller support portion is adjusted relative to the hinge assembly accordingly so that the use of different sized hinges are no longer required during the installation of overhead retractable door panels.

### CROSS-REFERENCE TO RELATED APPLICATIONS/INCORPORATION BY REFERENCE

This patent application claims the priority to U.S. provisional patent application Ser. No. 60/570,538 which was filed on May 12, 2004, and is incorporated herein by reference in its entirety.

### TECHNICAL FIELD

The present invention relates to an adjustable roller bracket device for a garage door hinge. More particularly, the present invention relates to an adjustable roller bracket device used in conjunction with a single type of garage door hinge for use with overhead door constructions wherein a plurality of hingedly connected panels are employed.

### BACKGROUND OF THE INVENTION

Overhead doors are well known. Especially common are sectional, roll up doors that employ a pair of tracks for rollers. Each track has a vertical portion for retaining door panels in a vertical or closed orientation, and each track has a horizontal portion for retaining door panels in a horizontal or open orientation.

There are numerous designs of overhead or retractable door assemblies which are commonly used for garage doors, truck doors, warehouse doors, etc. Such doors can be manually operated, or can be automatically operated using electric motors or the like, to pull the panels of the door upwardly along the tracks, when the door is being opened, or push the door downwardly to a closed position, when reversed. Such retractable overhead doors are conventionally constructed of a number of vertically arranged horizontal panels which can fold along the horizontal divisions between the panels, thereby enabling the doors to assume the configuration of a curved track as they moved between closed and retracted positions. The panels assume a vertically juxtaposed planar configuration when in the closed position to thereby present a solid face and close the door opening. The vertically arranged horizontal panels are connected by two or more hinge assemblies between each of the adjacent horizontal panels. The hinge assemblies are typically provided at least at each side of the door, and include a roller adapted to run in parallel tracks which are installed vertically on each side of the door. The track then curves at the top before becoming horizontal parallel tracks, suspended from the ceiling for example.

For proper installation of such doors, different types of hardware may be necessary. For example, certain retractable door designs have the side guide tracks installed at an angle so that the door panels approach the door frame as the door panels are lowered into position. This design ensures that the door panels are moved against the door frame when the retractable door is in a lowermost closed position. This design, however, requires hinges of different design at various panel elevations on the door in order to accommodate the different distances from the side guide tracks to the door frame. These hinges are typically numbered from #1 to #13 to accommodate most designs of retractable door. The hinge brackets which connect the several door sections and carry the rollers are therefore usually made with different fixed amounts of offset between the inner face of the door and the axis of the roller depending upon the position of the hinge bracket is to assume relative to the door and tracks. If the hinge is to be near the top of the door, the offset must be greater since in this region the track is farther away from the doorjamb relative to the hinges near the bottom of the door.

A number of different hinges must be therefore be manufactured, raising the costs thereof. Further, the user must maintain an inventory of all the different types of hinges that are used during the installation of retractable doors. It would therefore be desirable to eliminate the plurality of standard hinges, to provide cost savings and ease of use. The user would greatly benefit by utilizing a single type of garage door hinge in conjunction with an adjustable roller bracket device for a garage door hinge during the installation of a garage door.

The hinges used in installation of retractable doors are also generally constructed of relatively thin gauge material. This results in a hinge construction which may not provide sufficient support for very large door configurations or if unusual forces are applied to the door. For example, in areas that may experience high winds, such as from a hurricane or the like. In areas susceptible to such forces, building codes may require retractable doors constructed with typical hinges to be fortified or reinforced, adding to the installation time and cists. It would therefore be worthwhile to provide a hinge construction which would provide more structural integrity in heavier duty applications.

### SUMMARY OF THE INVENTION

Based on the foregoing, there is a need to provide a device which will enable an adjustable roller bracket device to be used in conjunction with a single type of retractable door hinge for use with overhead door constructions wherein a plurality of hingedly connected panels are employed. The present invention is therefore directed to an adjustable roller bracket device which is cost-effective as well as being easily used and maintained. An embodiment of the present invention comprises an adjustable roller bracket for a retractable door hinge. The adjustable roller bracket includes a mounting portion, wherein the mounting portion comprises a horizontal face having a first aperture and an upstanding plate member having a mounting section with a second aperture therein, an adjustable roller support portion, wherein the roller support portion comprises a tubular support member and at least a third aperture and wherein a fastener secures the roller support portion to the mounting section in a predetermined position.

Another embodiment of the present invention comprises door hinge assembly. The door hinge assembly includes a plurality of hinge plates and a roller bracket member, wherein the roller bracket member is selectively coupled to the hinge members.

Another embodiment of the present invention provides a method of utilizing a single type of garage door hinge assembly during the installation of a retractable garage door system. The method comprises providing a garage door hinge assembly comprising a first and second mounting plate, wherein each mounting plate has at least one aperture and a pair of spaced ears extending from each mounting plate and having an aperture therein for supporting a horizontal tube, wherein the tube provides a stationary bearing support for a shaft associated with a roller. The method also includes providing an adjustable roller bracket comprising a mounting portion, wherein the mounting portion comprises a horizontal face having a first aperture and an upstanding plate member having a second aperture and an adjustable roller support portion, wherein the roller support portion comprises a tubular support member and a third aperture. The method also includes providing a plurality of spaced roller guide tracks mounted on the interior of a building, securing the garage door hinge assembly onto a pair of adjacent garage door panels, placing the roller bracket onto the first mounting plate or the second mounting plate, securing the roller bracket onto the first or second mounting plate and adjusting the roller support portion such that the tubular support member is capable of accommodating a shaft of a roller, thereby connecting the track and door panels.

The invention and embodiments thereof which are shown and described in the following description and drawings, achieves these and other objects and advantages of the present invention.

### BRIEF DESCRIPTION OF THE DRAWINGS

FIG. 1 is a perspective view of a roller bracket device according to an embodiment of the present invention positioned with a standard retractable door hinge.

FIG. 2 is a front perspective view of the roller bracket device as shown in the embodiment of FIG. 1.

FIG. 3 is a rear perspective view of the roller bracket device as shown in the embodiment of FIG. 1.

### DETAILED DESCRIPTION OF A PREFERRED EMBODIMENT

In the assembly of a sectional, retractable, overhead door, a plurality of horizontal door sections or panels are connected together by vertically positioned hinge plates spaced along the side edge portions thereof. The door slides along parallel spaced roller guide tracks mounted on the interior of the building, it is conventional to mount a roller on the side of each hinge plate to connect the track and door panels.

In most modern retractable overhead door constructions, it is customary to have the rising leg of each track inclined away from the doorjamb or frame. To accommodate this, it is necessary that the rollers of successive hinge assemblies are spaced further and further away from the attached hinge plates, so that the door sections adopt a vertical position when closing the door opening. Therefore, it is typically necessary for an installer to stock a different hinge unit for each door panel section of the door to be installed.

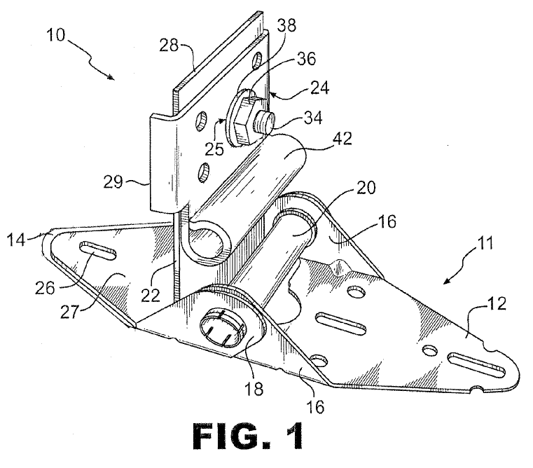

To overcome this difficulty, the present invention provides an adjustable roller bracket device for a retractable door hinge. The adjustable roller bracket device 10 of an embodiment for use with a conventional door hinge is illustrated in FIG. 1. As seen in FIG. 1, a roller bracket device 10 is usable in conjunction with a standard hinge assembly 11, which may be a #1 hinge commonly used in installation of retractable door systems. In this manner, where a #1 hinge can be used in installing a retractable door, the standard hinge 11 may be used, while for other hinge locations, the #1 hinge assembly 11 may then be combined with the adjustable roller bracket 10 according to the invention for use at other locations in the retractable door system. Although this will allow use of a standard hinge assembly 11 which is presently commonly used in the installation of such door systems, the invention also contemplates use of another standard hinge assembly other than a #1 hinge as shown herein. For example, instead of add-on apparatus for use with a standard #1 hinge assembly 11, as an example, the hinge assembly itself may be formed to accomplish the same function, including working similarly to the standard #1 hinge. For example, a pair of hinge plates may be provided for coupling of adjacent panels of a retractable door system, with provision of an adjustable roller bracket member for mounting of a roller in association therewith. The integrated adjustable roller bracket device 10 may be used for all roller locations and installation of the door system. The adjustable roller bracket device 10 of the invention along with a standard base hinge configuration may therefore replace the #1 hinge assembly along with the other standard hinge configurations #2-#13, which are presently used. In either of such embodiments of the present invention, the adjustable roller bracket is capable of being placed and secured in association with a hinge assembly. In the embodiment shown, a standard hinge assembly 11 may include first and second mounting plates 12 and 14, each of which is selectively attachable to a respective panel in a retractable door system in a known fashion. A pair of spaced ears 16 and 18 extend from each of the mounting plates 12 and 14, and each have an aperture therein for supporting a horizontal tube 20. The tube 20 extends thru the apertures in the ears so as to be fixed in association with each of the mounting plates 12 and 14, and to allow relative movement of the plates 12 and 14 relative to one another about the axis of the tube 20. In practice, the tube 20 provides a stationary bearing support for a shaft or stem associated with a roller (not shown) mounted in association with the hinge assembly 11. As previously mentioned, other standard hinge assemblies, such as #2 thru #13, are configured somewhat similarly, other than the support tube 20 positioned at a different distance spaced outwardly from the plates 12 and 14. To avoid use of multiple hinge configurations, the roller bracket device 10 according to the invention, may be selectively coupled to or integrated with one of the plates 12 or 14 to facilitate use at other locations in the retractable door assembly. In this embodiment, adjustable bracket 10 comprises an L-shaped mounting portion 22 and an adjustable roller support portion 24.

As illustrated in FIGS. 1-3, the adjustable roller bracket device 10 of this embodiment is fitted onto the lower base 14 of a standard single axle #1 garage door hinge 11 in order to adapt the standard hinge 11 for use at other locations in a retractable door system, rather than standard hinges #2-#13. The adjustable roller bracket device 10 is constructed to have L-shaped mounting portion 22 which has apertures 26 therein that match the fastener apertures in the mounting plate 14 of the hinge 11. As merely an example, a bolt or screw may be used to secure the mounting portion 22 to plate 14 of hinge assembly 11, or the same fastener used to secure plate 14 to a panel of the door system may be positioned to secure portion 22 with plate 14. The aperture 26 permits the horizontal face 27 of mounting portion 22 to be slidably fixed in a plane parallel to that of hinge assembly 11. The aperture 26 may be configured as an elongated hole to allow adjustment of the position of portion 22 relative to plate 14. Alternatively, as should be recognized, plate 27 of mounting portion 22 may be selectively attached to mounting plate 12 in an opposing configuration if desired. Thus, when the mounting portion 22 is secured to a mounting plate 12 or 14 associated with hinge 11, it becomes integral with hinge 11. Mounting portion 22 also includes an upstanding plate member 28 which extends outwardly from the mounting plate 14 (or 12) when mounting portion 22 is secured in association with hinge 11. The plate 28 provides a mounting section for an adjustable roller support portion 24 which is adjustably secured in association with plate 28 of device 10.

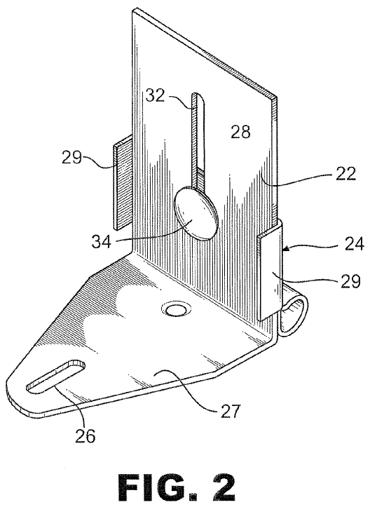

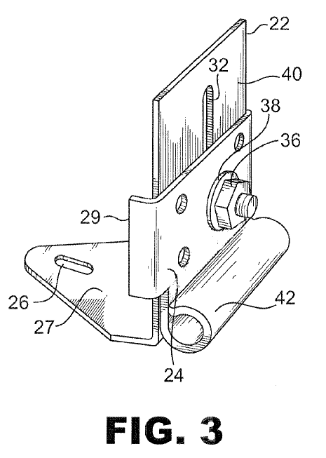

As illustrated in FIGS. 2 and 3, an elongated aperture 32 formed in plate 28 allows adjustable roller support portion 24 to move along a face 40 of plate 28. This, in turn, moves the tubular support member 42 along an axis orthogonal to the hinge rotational axis between hinge mounting plates 12 and 14. A fastener, such as a screw or bolt 34 is inserted through aperture 32 and a corresponding aperture 25 in adjustable roller support portion 24. The screw or bolt 34 is secured in a desired position on mounting portion 22 with a nut 36 and washer 38. Other fasteners may be used as desired.

As illustrated in FIGS. 1 and 2, adjustable roller support portion 24 also has formed in the lower end thereof a tubular support member 42 that is capable of receiving the shaft or stem of a roller, similar to tube 20 as described with reference to hinge 11. By adjusting the placement of adjustable roller support portion 24, on the mounting portion 22, in effect the combination of adjustable roller bracket device 10 and hinge 11 effectively replaces #2-#13 hinges that are used during the installation of a garage door. As shown in the Figs., the adjustable roller support portion 24 may be positioned with the mounting tube 42 adjacent hinge 11, or roller support portion 24 may be flipped so that tubular support 42 is positioned distal to hinge 11. This alternative positioning along with adjustment of the roller support portion 24 with respect to mounting plate 28, allows positioning of the tubular support 42 at any desired position relative to the hinge 11 so as to accommodate the standard offsets experienced in retractable door assembly installations. As should also be recognized, the adjustable roller support portion 24 may be mounted on the opposing side of plate 28, with full adjustability of positioning the tubular support member 42 relative to hinge 11 as previously described. To facilitate positioning of roller support portion 24 on plate 28, the support portion 24 may be configured with opposing flanges 29 which extend around the plate 28 to facilitate sliding relationship between support portion 24 and plate 28. The flanges 29 further provide rigidity in the construction for increased structural integrity.

In the embodiment of the present invention as shown in the Figs., it is noted that the hinge 11, being a standard #1 hinge assembly, is constructed of a metal material having a certain gauge or thickness. Typically, the standard hinge assemblies 11 utilize are constructed of 14-gauge material, which in certain applications, simply does not provide sufficient structural integrity to withstand expected forces, such as may be encountered in a hurricane or the like, or to properly support larger and heavier retractable door systems. It is therefore an aspect of the invention to provide device 10 with increased structural integrity, such that when combined with the standard hinge assembly 11, provides a hinge and roller support assembly which has greatly increased structural integrity. As an example, the device 10 may be constructed of an 11-gauge material, being substantially thicker than the typical materials from which hinge assembly 11 is formed, to increase rigidity and load carrying capacity. Further, for desired applications, providing support tube 42 on the roller support portion 24, enables larger, higher load carrying rollers to be used in conjunction therewith. In standard hinge assemblies 11, the standard roller axle or stem has a diameter or 7/16 inches, which may not be suitable for withstanding significant forces or for use with large heavy retractable door systems. The provision of a separable and adjustable roller support portion 24 enables different roller configurations to be used, to provide the desired structural integrity for a particular application. For example, the tubular support 42 may be configured to support a larger roller axle or shaft, such as a 5/8 inch diameter shaft rather than the standard 7/16 inch shaft. Other roller configurations may also be easily accommodated by merely providing alternative axle support 42 in conjunction with support portion 24.

In accordance with the present invention, the adjustable roller bracket device 10 allows adjustment of roller support portion 24 to accommodate all of the various offsets which may be encountered in installation of a retractable door system. It is particularly advantageous if odd height door configurations are encountered, wherein standard #1-#13 hinges simply will not accommodate other than standards height door configurations. With the full and continuous adjustability of support portion 24 relative to hinge assembly 11, any such atypically installations may also be accommodated. Although any desired adjustment is contemplated in the present invention, adjustability of the position of support tube 42 relative to hinge 11 may be up to 5 inches, which would allow use for all standard hinge configurations #2-#13.

The foregoing description of the preferred embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An adjustable roller bracket for a retractable door hinge, the roller bracket comprising:
a mounting portion, wherein the mounting portion comprises an upstanding plate member having a mounting section;
an adjustable roller support portion, wherein the roller support portion comprises a tubular support member and at least one aperture; and
wherein the roller support portion is selectively secured to the mounting section in a predetermined position.

2. The adjustable roller bracket of claim 1, wherein the mounting section has at least one aperture in the upstanding plate member, which is configured as an elongated hole allowing adjustment of the mounting portion relative to a plate of a garage door hinge assembly.

3. The adjustable roller bracket of claim 1, wherein the mounting portion further comprises a hinge mounting portion for mounting to a standard retractable door hinge.

4. The adjustable roller bracket of claim 3, wherein the mounting portion has at least one aperture which is configured as an elongated hole allowing adjustment of the hinge mounting portion relative to a hinge to which it is selectively attached.

5. The adjustable roller bracket of claim 3, wherein the mounting portion is configured in an L-shape with the hinge mounting portion being selectively attached to a mounting plate of a standard hinge assembly.

6. The adjustable roller bracket of claim 1, wherein the upstanding plate member extends outwardly from the hinge assembly when the mounting portion is secured to the hinge assembly.

7. The adjustable roller bracket of claim 1, wherein the upstanding plate member is configured to allow the roller support portion to be variably positioned along a face of the upstanding plate member.

8. The adjustable roller bracket of claim 7, wherein a fastener is used to selectively secure the roller support portion in a desired position on the mounting portion.

9. The adjustable roller bracket of claim 1, wherein the position of the tubular support member is adjustable between standard hinge configurations #2 through #13.

10. The adjustable roller bracket of claim 1, wherein the roller support portion further comprises a plurality of flanges extending around the upstanding plate member when secured thereto to provide rigidity to the roller support portion, thereby increasing the structural integrity of the roller support portion.

11. The adjustable roller bracket of claim 1, wherein the roller bracket is prepared from at least 11-gauge material, thereby increasing rigidity and load carrying capacity of the bracket.

12. A method of utilizing a single type of garage door hinge assembly during the installation of a retractable garage door system, the method comprising:
providing a garage door hinge assembly comprising:
a first and second mounting plate, and a pair of spaced ears extending from each mounting plate and supporting a tube, wherein the tube provides a stationary bearing support for a shaft associated with a roller;
providing an adjustable roller bracket comprising:
a mounting portion, wherein the mounting portion comprises an upstanding plate member; and
an adjustable roller support portion, wherein the roller support portion comprises a tubular support member;
providing a plurality of spaced roller guide tracks mounted on the interior of a building;
securing the single type of garage door hinge onto a pair of adjacent garage door panels;
securing the roller bracket onto the hinge such that the upstanding plate extends outwardly from the hinge;
securing the roller bracket onto the first or second mounting plate; and
adjusting and securing the roller support portion to the upstanding plate such that the tubular support member is positioned variably with respect to the hinge and is capable of accommodating a shaft of a roller, thereby connecting the track and door panels.

13. A retractable door hinge assembly comprising:
a plurality of hinge plates; and
a roller bracket member, wherein the roller bracket member is selectively coupled to the hinge members in variable positions, the roller bracket member comprising a tubular support member capable of accommodating a shaft of a roller at different positions relative to the hinge plates.

14. The door hinge assembly of claim 13, wherein the hinge plates couple adjacent panels of a retractable garage door system.

15. The door hinge assembly of claim 13, wherein the different positions of the tubular support member replace the standard hinge configurations #2 through #13.

16. The door hinge assembly of claim 13, wherein the tubular support member is variably positioned along an axis orthogonal to the hinge axis.
